(19) United States
(12) Patent Application Publication
(10) Pub. No.: US 2025/0252635 A1
(43) Pub. Date: Aug. 7, 2025

(54) CREATION ASSISTANCE SYSTEM AND CREATION ASSISTANCE METHOD

(71) Applicant: Wacom Co., Ltd., Saitama (JP)

(72) Inventors: Hiroshi TAMANO, Saitama (JP); Nobutaka IDE, Saitama (JP); Jin-Fu KO, Saitama (JP)

(21) Appl. No.: 19/187,634

(22) Filed: Apr. 23, 2025

Related U.S. Application Data
(63) Continuation of application No. PCT/JP2023/038489, filed on Oct. 25, 2023.

(30) Foreign Application Priority Data
Nov. 2, 2022 (JP) 2022-176003

(51) Int. Cl. G06T 11/60; G06T 11/00

(52) U.S. Cl. CPC G06T 11/60; G06T 11/001; G06T 2200/16; G06T 2200/24

(57) ABSTRACT

The present disclosure relates to a creation assistance system and a creation assistance method. The creation assistance system includes a creator terminal configured to create content through an input operation by a creator, and a server device capable of communicating bidirectionally with the creator terminal The creator terminal transmits, to the server device, partial data including the content data which has been generated in units of content creation. The server device stores accumulated data by accumulating the partial data received from the creator terminal, executes a drawing application having a reproduction function, generates reproduction data to visibly reproduce the content, which is being created or has been completed by the creator, by using the content data included in the accumulated data through the reproduction function of the drawing application, and transmits the reproduction data to the creator terminal for display.

### BACKGROUND

### Technical Field

The present disclosure relates to a creation assistance system and a creation assistance method.

### Description of the Related Art

A technology is known which uses a computer system to assist a creator in creation of intangible digital content (hereinafter also referred to simply as “content”).

PCT Patent Publication No. WO 2021/049602 discloses a client server system in which a tablet and an external server cooperate with each other to superimpose and display second content obtained through a search using the external server on first content displayed on the tablet.

### BRIEF SUMMARY

When a creator creates complex content such as digital art using a system of the type disclosed in PCT Patent Publication No. WO 2021/049602, a large amount of content data is generated during a creation process. Thus, when a system is configured such that a client terminal handles all rendering processing, for example, when the creator retrospectively checks content in past drawing states in a creation process, a computation load on the client terminal due to the rendering processing is increased.

According to one aspect, the present disclosure provides a creation assistance system and a creation assistance method that can reduce a computation load on a client terminal due to rendering processing.

According to a first aspect, a creation assistance system is a system including a creator terminal for creating content through an input operation by a creator, and a server device capable of communicating bidirectionally with the creator terminal. The creator terminal includes a creator-side controller and a creator-side storage. The creator-side controller is configured to execute a first drawing application having a generation function of generating content data representing drawing of the content, and a first reproduction function of visibly reproducing the content from the content data. The creator-side controller performs communication control to transmit, to the server device, partial data including the content data which is generated in units of content creation. The server device includes a server-side controller and a server-side storage. The server-side storage is configured to store accumulated data by accumulating the partial data received from the creator terminal. The server-side controller is configured to execute a second drawing application having a second reproduction function identical or corresponding to the first reproduction function, to generate reproduction data for visibly reproducing the content in the making or the completed content, by using the content data included in the accumulated data stored in the server-side storage through the second reproduction function of the second drawing application, and to perform communication control to transmit the generated reproduction data to the creator terminal.

According to a second aspect, a creation assistance method is provided which uses a system including a creator terminal for creating content through an input operation by a creator and a server device capable of communicating bidirectionally with the creator terminal. The method includes generally six steps. First, the creator terminal executes a first drawing application having a generation function of generating content data representing drawing of the content and a first reproduction function of visibly reproducing the content from the content data. Second, the creator terminal transmits, to the server device, partial data including the content data which is generated in units of content creation. Third, the server device stores accumulated data by accumulating the partial data received from the creator terminal. Fourth, the server device executes a second drawing application having a second reproduction function identical or corresponding to the first reproduction function. Fifth, the server device generates reproduction data for visibly reproducing the content in the making or the completed content, by using the content data included in the accumulated data stored in the server-side storage through the second reproduction function of the second drawing application. Sixth, the server device transmits the generated reproduction data to the creator terminal.

According to the present disclosure, it is possible to reduce a computation load on the client terminal due to rendering processing.

### BRIEF DESCRIPTION OF THE SEVERAL VIEWS OF THE DRAWINGS

FIG. 1 is a general configuration diagram of a creation assistance system in one embodiment of the present disclosure;

FIG. 2 is a block diagram illustrating an example of a configuration of a server device in

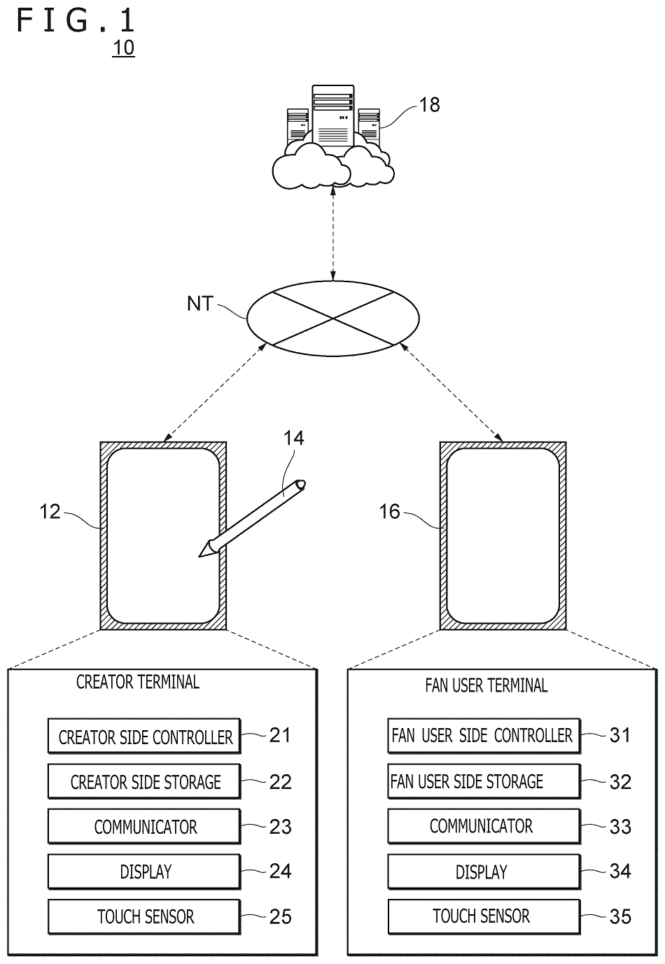

FIG. 1;

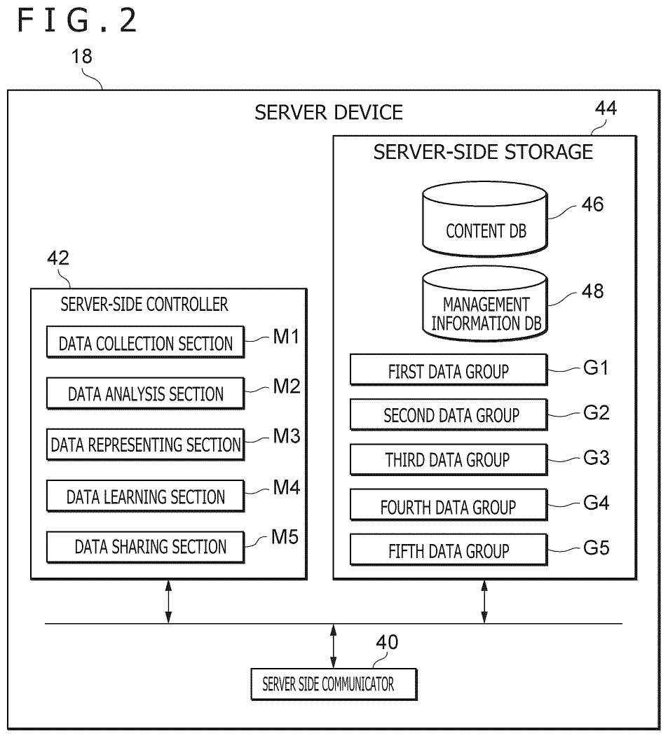

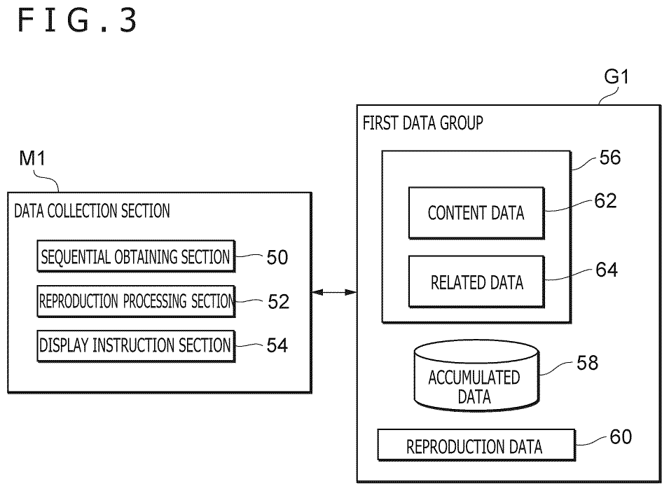

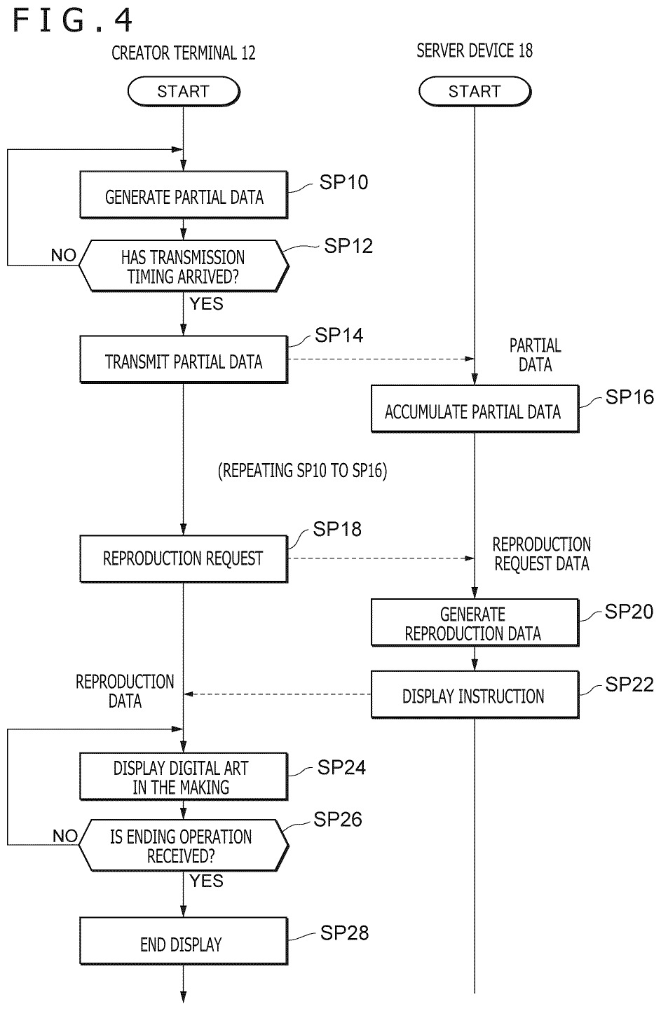

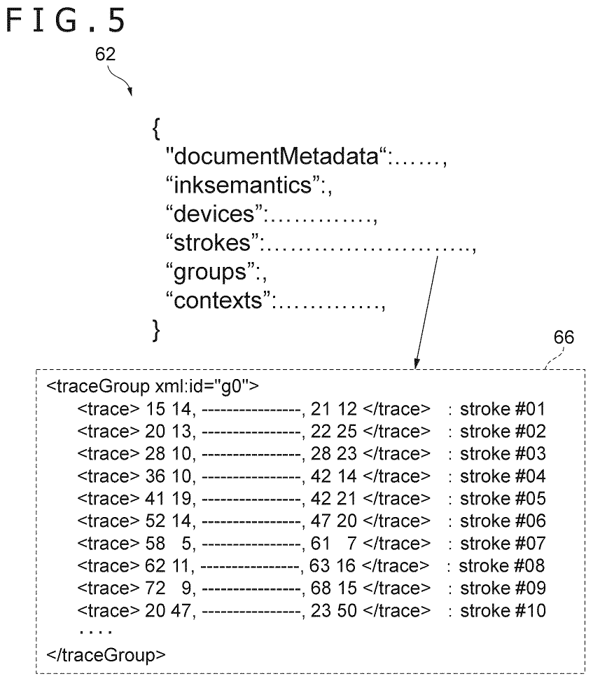

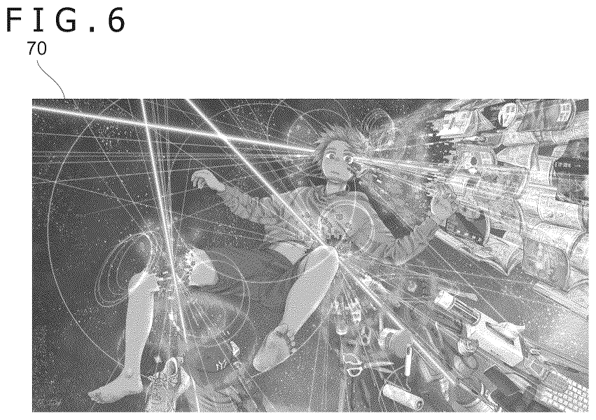

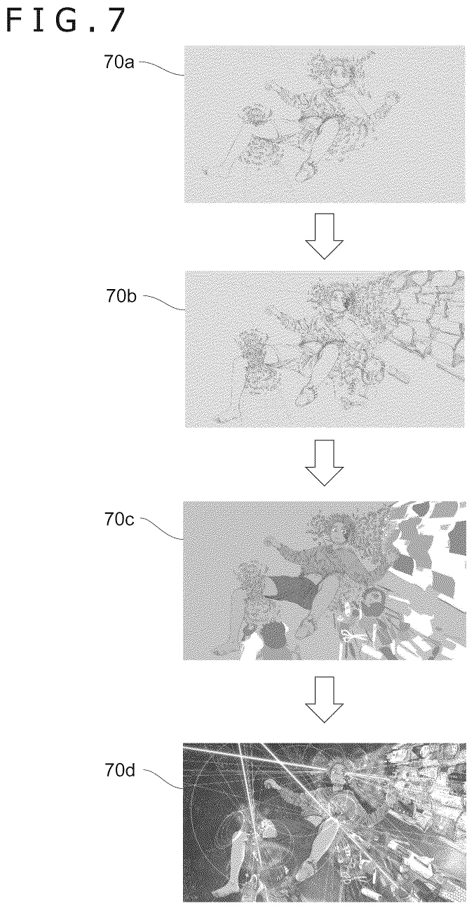

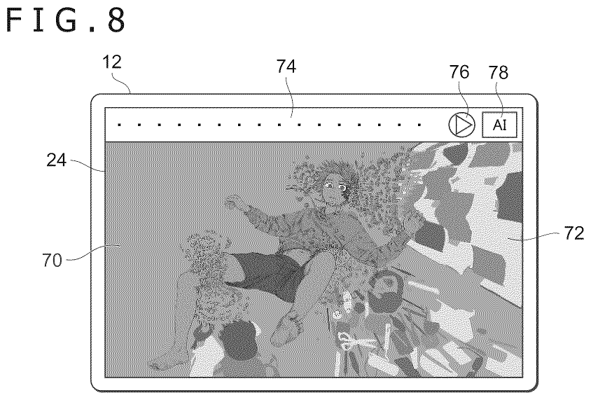

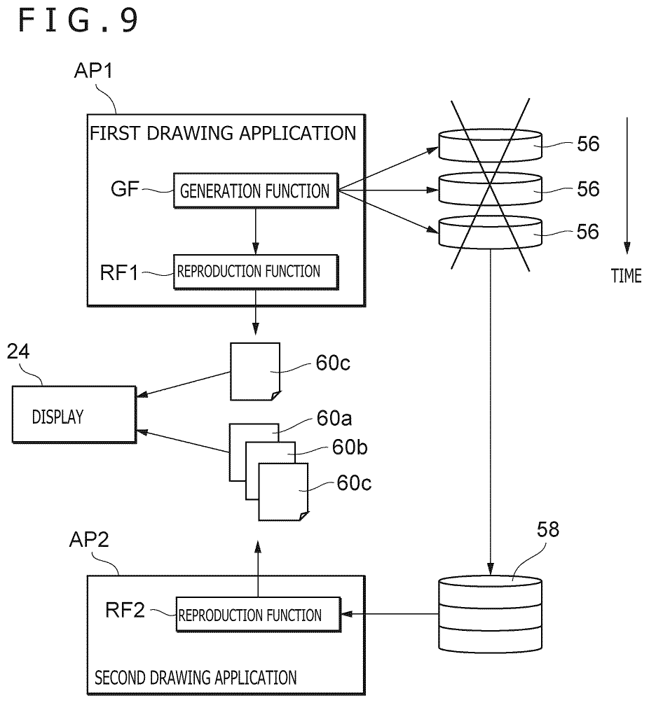

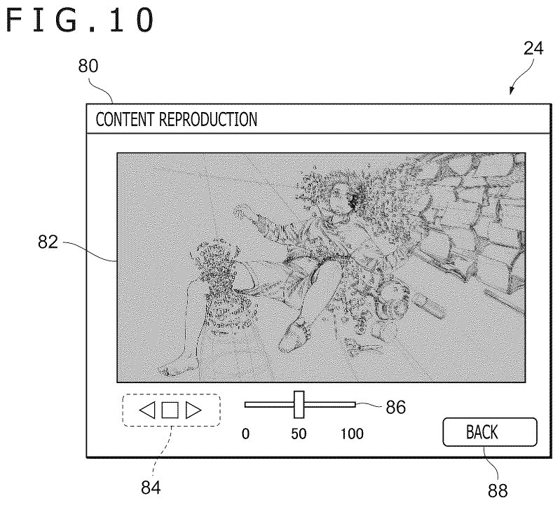

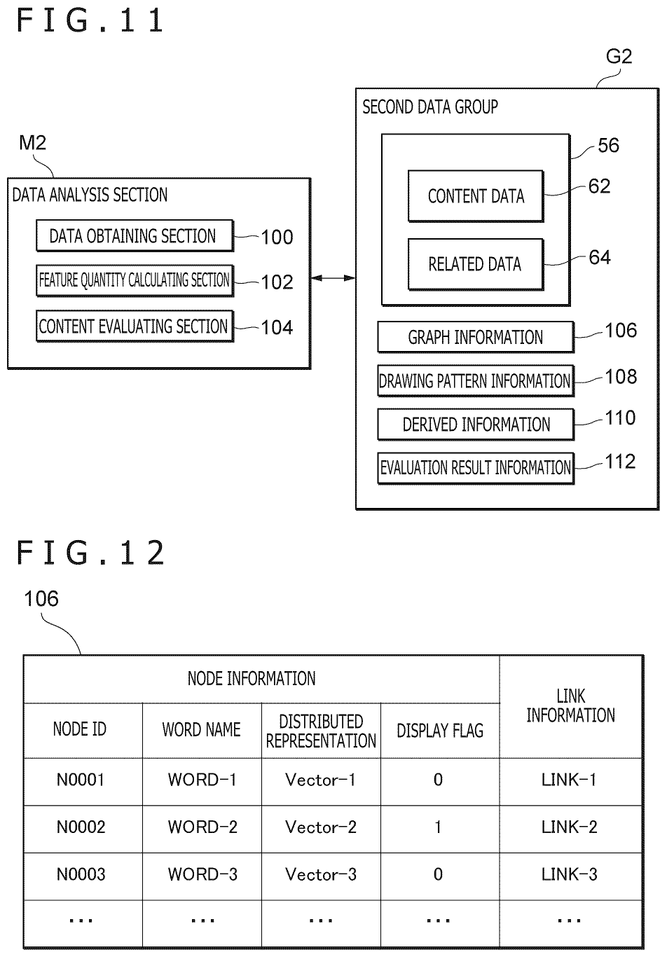

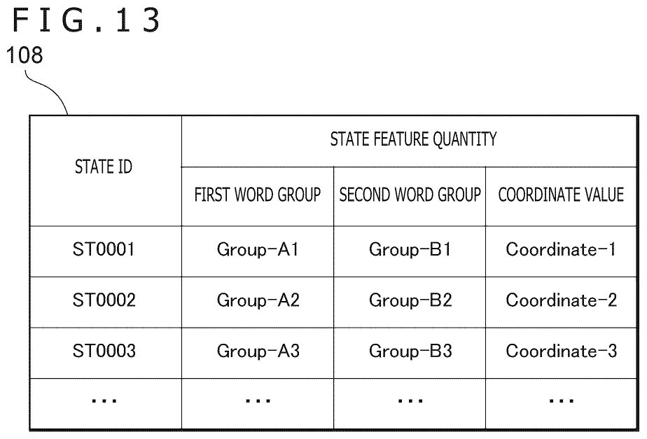

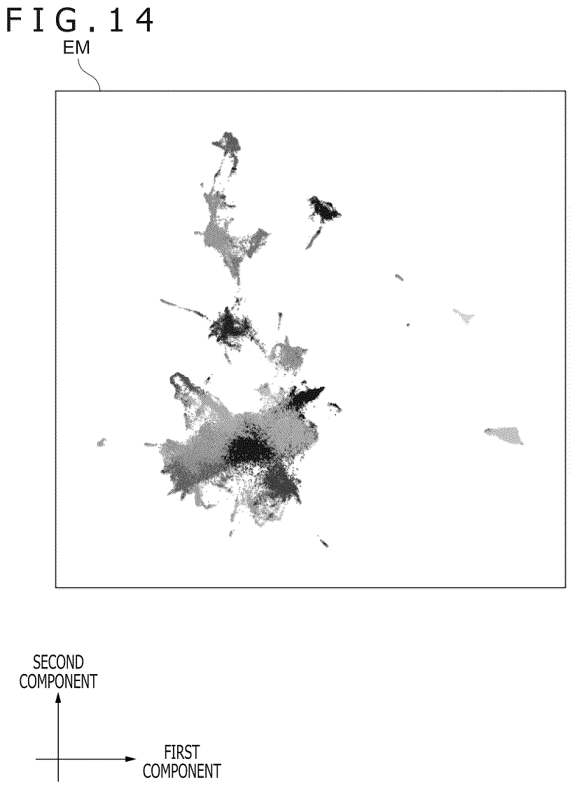

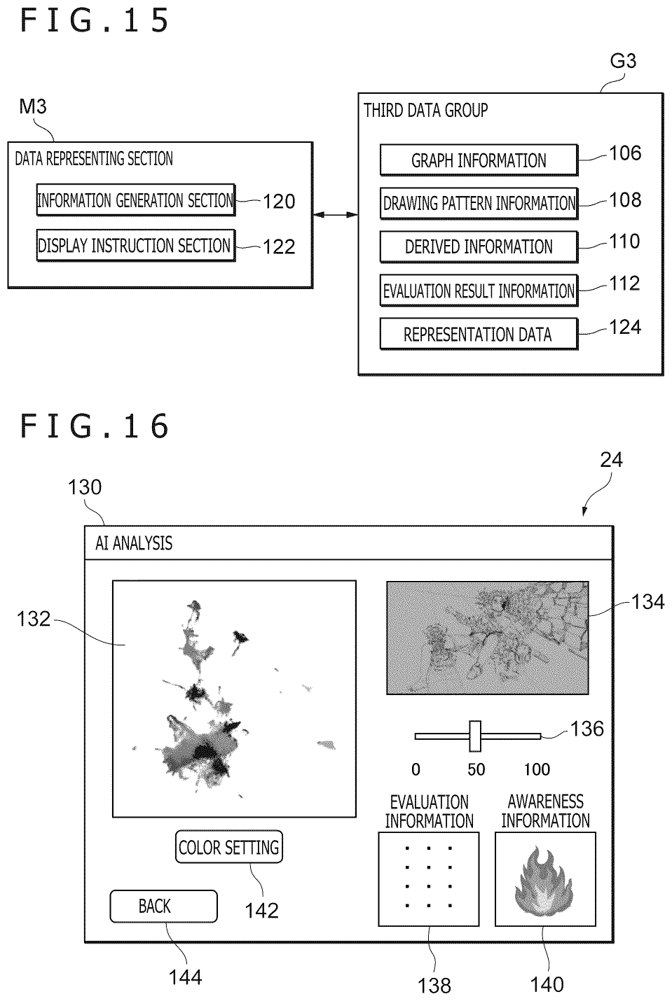

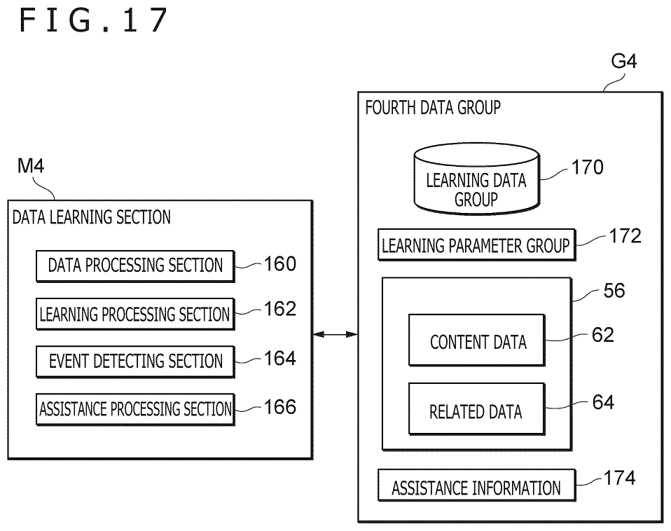

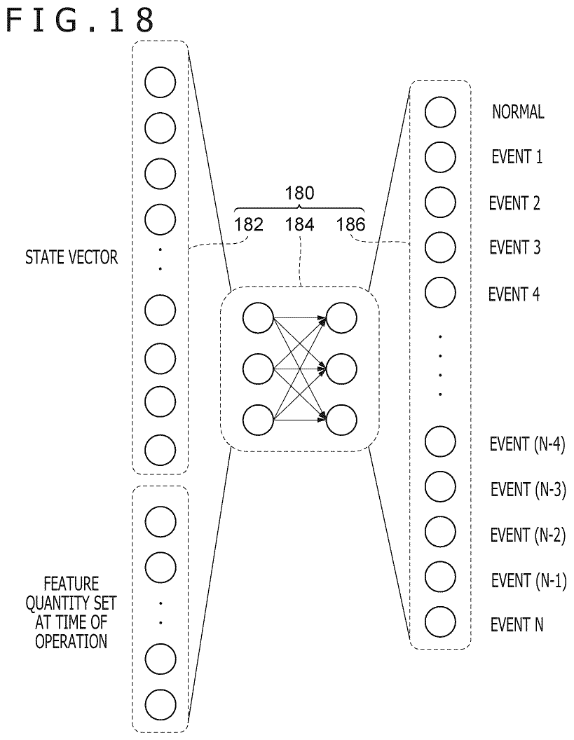

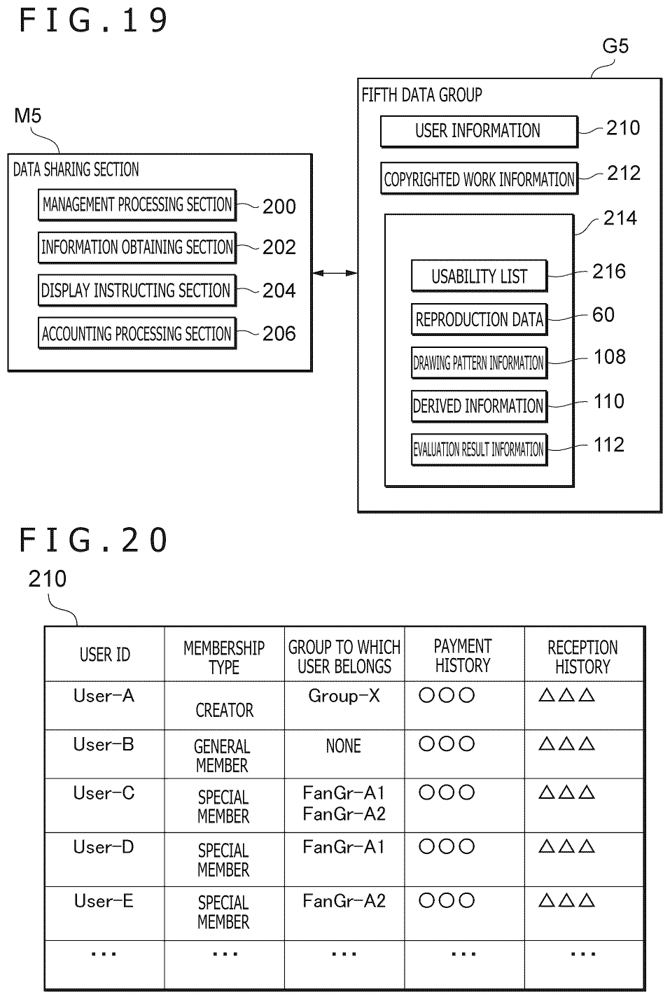

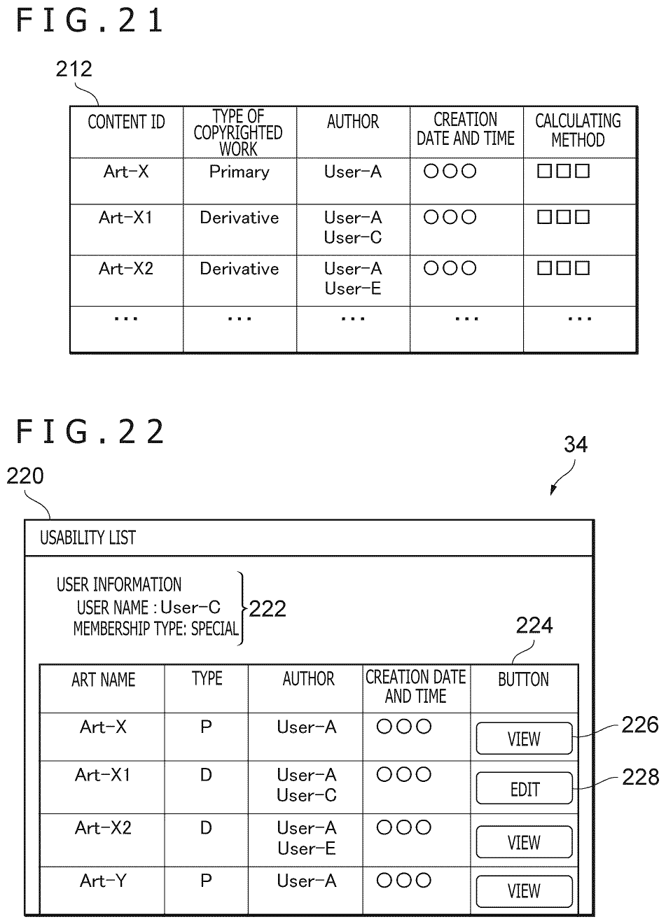

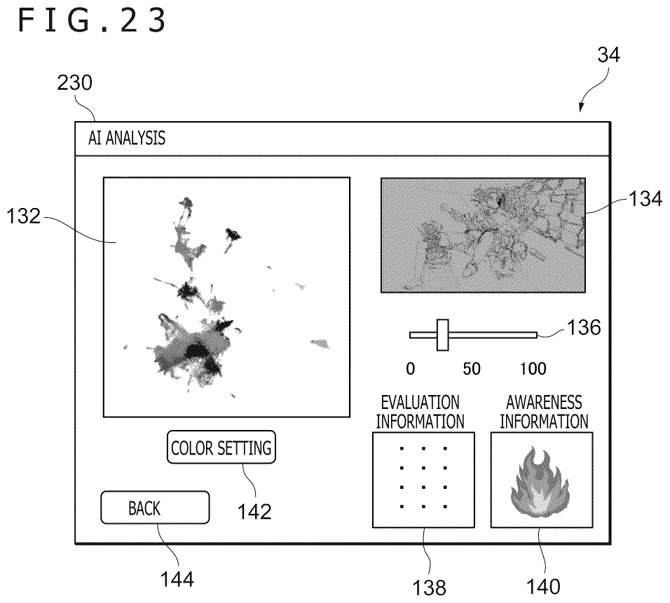

FIG. 3 is a diagram illustrating each of functional blocks of a data collection section in FIG. 2 and a data configuration of a first data group in FIG. 2;

FIG. 4 is a sequence diagram illustrating a data collecting operation by a creator terminal and the server device;

FIG. 5 is a diagram illustrating an example of a data structure of content data in FIG. 3;

FIG. 6 is a diagram illustrating an example of content created by a creator;

FIG. 7 is a diagram illustrating transitions of the drawing state of digital art in FIG. 6;

FIG. 8 is a diagram illustrating an example of a content creating screen that is displayed on a display of the creator terminal;

FIG. 9 is a diagram schematically illustrating a relation between a first drawing application and a second drawing application;

FIG. 10 is a diagram illustrating an example of a content reproduction screen that is displayed on the display of the creator terminal;

FIG. 11 is a diagram illustrating each of functional blocks of a data analysis section in FIG. 2 and a data configuration of a second data group in FIG. 2;

FIG. 12 is a diagram illustrating an example of a data structure of graph information in FIG. 11;

FIG. 13 is a diagram illustrating an example of a data structure of drawing pattern information in FIG. 11;

FIG. 14 is a diagram illustrating an example of a visualized drawing pattern;

FIG. 15 is a diagram illustrating each of functional blocks of a data representing section in FIG. 2 and a data configuration of a third data group in FIG. 2;

FIG. 16 is a diagram illustrating an example of an analysis result screen that is displayed on the display of the creator terminal;

FIG. 17 is a diagram illustrating each of functional blocks of a data learning section in FIG. 2 and a data configuration of a fourth data group in FIG. 2;

FIG. 18 is a diagram illustrating an example of a network structure of a discriminator for detecting an event;

FIG. 19 is a diagram illustrating each of functional blocks of a data sharing section in FIG. 2 and a data configuration of a fifth data group in FIG. 2;

FIG. 20 is a diagram illustrating an example of a data structure of user information in FIG. 19;

FIG. 21 is a diagram illustrating an example of a data structure of copyrighted work information in FIG. 19;

FIG. 22 is a diagram illustrating an example of a list viewing screen that is displayed on a display of a fan user terminal; and

FIG. 23 is a diagram illustrating an example of an analysis result screen that is displayed on the display of the fan user terminal.

### DETAILED DESCRIPTION

Embodiments of the present disclosure will hereinafter be described with reference to the accompanying drawings. In order to facilitate understanding of the description, identical constituent elements in the drawings are denoted by the same reference signs where possible, and redundant description thereof will be omitted. In addition, the word “section” may be replaced with another word such as, for example, a unit, a module, a device, or an element.

### Configuration of Creation Assistance System 10

### General Configuration

FIG. 1 is a general configuration diagram of a creation assistance system 10 in one embodiment of the present disclosure. The creation assistance system 10 provides a “creation assistance service” to assist a creator in the creation of content. The creation assistance system 10 in one example includes at least one creator terminal 12, at least one electronic pen 14, at least one fan user terminal 16, and at least one server device 18. Each creator terminal 12 and each server device 18 are communicably connected to each other via a network NT. Similarly, each fan user terminal 16 and each server device 18 are communicably connected to each other via the network NT.

The creator terminal 12 is a computer owned by a user (for example, a creator of digital art) who receives the creation assistance service. The creator terminal 12 may be, for example, a tablet, a smart phone, a personal computer, or the like. The creator terminal 12 is configured to be able to transmit, to the server device 18 via the network NT, various types of data generated through creation activity. The creator terminal 12 includes, for example, a creator-side controller 21, a creator-side storage 22, a communicator 23, a display 24, and a touch sensor 25.

The fan user terminal 16 is a computer owned by a user (for example, a fan user of the creator) who uses the creation assistance service. The fan user terminal 16 may be, for example, a tablet, a smart phone, a personal computer, or the like. The fan user terminal 16 is configured to be able to receive, from the server device 18 via the network NT, various types of data generated through the creation activity of the creator. The fan user terminal 16 includes, for example, a fan user side controller 31, a fan user side storage 32, a communicator 33, a display 34, and a touch sensor 35.

The creator-side controller 21 is constituted by, for example, an arithmetic processing device including a central processing unit (CPU), a graphics processing unit (GPU), or a micro-processing unit (MPU). The creator-side controller 21 reads a program and data stored in the creator-side storage 22 to perform generation processing of generating ink data (hereinafter referred to also as a digital ink) which describes content, rendering processing of displaying the content represented by the digital ink, and so forth. The fan user side controller 31 can assume a configuration similar to that of the creator-side controller 21.

The creator-side storage 22 stores a program and data necessary for the creator-side controller 21 to control its various components and elements. The creator-side storage 22 is constituted by a non-transitory and computer readable storage medium. The fan user side storage 32 can assume a configuration similar to that of the creator-side storage 22.

The computer readable storage medium is constituted by: [1] a storage device such as a hard disk drive (HDD) and a solid state drive (SSD) included in a computer system, [2] a portable medium such as a magneto-optical disk, a read only memory (ROM), a compact disc read-only memory (CD-ROM), and a flash memory, or the like.

The communicators 23 and 33 have a communicating function of performing wired or wireless communication with an external device. The creator terminal 12 and the fan user terminal 16 can thereby exchange various types of data with the server device 18.

The displays 24 and 34 can visibly display content such as an image or video. The displays 24 and 34 are constituted by, for example, a liquid crystal panel, an organic electro-luminescence (EL) panel, or electronic paper. When the displays 24 and 34 have flexibility, the creator or the fan user can perform various input operations on a curved or bent touch surface of the terminal.

The touch sensors 25 and 35 may be a capacitive-type sensor formed by arranging a plurality of sensor electrodes in a planar shape. The touch sensors 25 and 35 include, for example, a plurality of X-line electrodes for detecting a position on an X-axis of a sensor coordinate system and a plurality of Y-line electrodes for detecting a position on a Y-axis of the sensor coordinate system. The touch sensors 25 and 35 may be self-capacitance-type sensors in which electrodes in a block shape are arranged in a two-dimensional lattice in place of the mutual capacitance-type sensor described above.

The electronic pen 14 is a pen-type pointing device. The electronic pen 14 is configured to be capable of communicating unidirectionally or bidirectionally with the creator terminal 12. The electronic pen 14 is, for example, an active capacitive stylus such as an active electrostatic (AES) stylus or an electromagnetic resonance (EMR) stylus. The creator can hold the electronic pen 14 and move the electronic pen 14 while pressing a pen tip thereof against the touch surface of the creator terminal 12 to draw a picture, text characters, and the like on the creator terminal 12.

The server device 18 is a computer that performs centralized control over content creation assistance. The server device 18 may be of a cloud-type or of a on-premise type. While the server device 18 is illustrated as a single computer, the server device 18 may be a computer group of a distributed system in place of a single computer.

### Block Diagram of Server Device 18

FIG. 2 is a block diagram illustrating an example of a configuration of the server device 18 in FIG. 1. The server device 18 includes, specifically, a server-side communicator 40, a server-side controller 42, and a server-side storage 44.

The server-side communicator 40 is an interface that transmits and receives electric signals to and from an external device. The server device 18 can thereby exchange various types of information with the creator terminal 12 or the fan user terminal 16.

The server-side controller 42 is constituted by a processor such as a CPU and a GPU. The server-side controller 42 reads and executes a program and data stored in the server-side storage 44 to functions as a data collection section M1, a data analysis section M2, a data representing section M3, a data learning section M4, and a data sharing section M5.

The server-side storage 44 stores the program and data necessary for the server-side controller 42 to control various components and elements. The server-side storage 44 is constituted by a non-transitory and computer readable recording medium. In the example of FIG. 2, the server-side storage 44 includes a database of content (hereinafter referred to as “content DB 46”) and a database for the creation assistance service (hereinafter referred to as “management information DB 48”), and the server-side storage 44 further stores a first data group G1, a second data group G2, a third data group G3, a fourth data group G4, and a fifth data group G5.

Various types of information related to content (hereinafter “content information”) is registered in a usable manner in the content DB 46. Examples of the content information include: [1] content data 62 in FIG. 3, [2] related data 64 in FIG. 3, and [3] information generated by using the content data 62 or the related data 64 (hereinafter referred to as generated information). The “generated information” includes drawing pattern information 108, derived information 110, and evaluation result information 112, to be described later (FIG. 11).

Various types of information for managing users of the service or managing the content are usably registered in the management information DB 48. Examples of management information include user information 210 and copyrighted work information 212, to be described later (FIG. 19).

### Description of Data Collecting Function

A first function (data collecting function) that is implemented by the creation assistance system 10 will next be described with reference to FIGS. 3 to 10.

### Functional Block Diagram

FIG. 3 is a diagram illustrating functional blocks of the data collection section M1 in FIG. 2 and a data configuration of the first data group G1. The data collection section M1 functions as a sequential obtaining section 50, a reproduction processing section 52, and a display instructing section 54. The first data group G1 includes partial data 56, accumulated data 58, and reproduction data 60.

The sequential obtaining section 50 sequentially obtains the partial data 56 transmitted periodically or aperiodically from the creator terminal 12. Each time the sequential obtaining section 50 obtains the partial data 56, the accumulated data 58 related to content being created is updated. The timing of the transmission is a point of time at which the partial data 56 is generated in a predetermined unit of content creation. The transmission timing may be, for example, any one of [1] a point of time at which an accumulated amount of the partial data 56 reaches an upper limit value, [2] a point of time at which an accumulated time of the partial data 56 reaches a threshold value, [3] a point of time at which the accumulated number of times of input operations reaches a threshold value, or [4] a point of time at which one input operation is performed.

The reproduction processing section 52 performs data processing on the accumulated data 58, to thereby generate the reproduction data 60 for reproducing content. For example, the reproduction processing section 52 identifies a specified point of time specified by the creator based on reproduction request data transmitted by the creator terminal 12, and generates the reproduction data 60 corresponding to the specified point of time. The “specified point of time” refers to one or a plurality of points of time within a creation period of the content. The “creation period” refers to a period from a starting point of time of creation to the latest point of time of creation (i.e., while the content is being created or when the content is completed).

In generating the reproduction data 60, the reproduction processing section 52 performs rasterization processing of converting vector data included in the content data 62, to be described later, into raster data. The “vector data” refers to data describing the content in a vector format, and specifically includes stroke data 66 (FIG. 5) which represents the forms of strokes (for example, the shape, thickness, color, and the like of each stroke). The “raster data” refers to data describing the content in a raster format, and specifically includes image data including a plurality of pixel values.

In response to the reproduction request data received from the creator terminal 12 (that is, a request from the creator), the display instructing section 54 instructs the creator terminal 12 to display the content being created, which is reproduced by the reproduction processing section 52. Specifically, the display instructing section 54 performs communication control to transmit the reproduction data 60 generated by the reproduction processing section 52 to the corresponding creator terminal 12.

The partial data 56 includes information related to drawing content in units of content creation, including at least the content and order of input operations sequentially performed by the creator. Specifically, the partial data 56 includes the content data 62 and the related data 64.

The content data 62 is an aggregate of content elements constituting the content, and is configured as capable of representing a creation process of the content. The content data 62 is constituted, for example, by ink data (hereinafter digital ink) which represents the content resulting from handwriting. “Ink description language” which describes digital ink includes, for example, Wacom ink layer language (WILL), ink markup language (InkML), and ink serialized format (ISF). The content may be, for example, digital art 70 (artwork) including a picture, calligraphic work, illustration, text characters, and the like.

The related data 64 includes various types of information related to the creation of the content. Examples of the related data 64 include [1] creator information including the identification information, attributes, and the like of the creator, [2] “device driver side setting conditions” such as the resolution, size, and type of the display 24, the detection capability and type of the touch sensor 25, or the shape of a pen pressure curve, and the like, [3] “drawing application side setting conditions” such as the type of the content, color information of a color palette or a brush, a setting of a visual effect, and the like, [4] “creator operation history” which is sequentially stored through the execution of a drawing application, [5] “biological data” representing a biological signal of the creator at the time of creation of the content, [6] “environment data” representing the state of an external environment at the time of creation of the content, or the like.

The accumulated data 58 is an aggregate of the partial data 56 sequentially obtained by the sequential obtaining section 50. The accumulated data 58 includes information regarding the drawing of the content corresponding to the latest point of time of creating (i.e., while the content is being created or after the content is completed).

The reproduction data 60 is data for visibly reproducing the content at a point of time specified by the creator. The reproduction data 60 includes, for example, raster data describing the content in a raster format. The specified point of time may be a point of time within the creation period, or may be two or more consecutive points of time or non-consecutive points of time.

### Description of Operation

A data collecting operation performed by the creation assistance system 10 will next be described with reference to a sequence diagram of FIG. 4 in further reference to FIGS. 5 to 10.

After starting a first drawing application AP1, in Step SP10 in FIG. 4, the creator terminal 12 sequentially receives input operations by the creator, and generates the partial data 56 of the content. In Step SP12, the creator terminal 12 checks whether or not a transmission timing for the partial data 56 generated in Step SP10 has arrived. When the transmission timing has not yet arrived (Step SP12: NO), the creator terminal 12 sequentially repeats Steps SP10 and SP12 until the transmission timing arrives. When the transmission timing has arrived (Step SP12: YES) on the other hand, the creator terminal 12 proceeds to next Step SP14.

In Step SP14, the creator terminal 12 transmits the partial data 56 accumulated in the current unit of content creation to the server device 18 in association with identification information of the content (for example, a content ID: Identification).

In Step SP16, the server device 18 receives the partial data 56 transmitted in Step SP14, and accumulates the partial data 56 in the server-side storage 44. The accumulated data 58 is thus updated to a latest state.

The creator terminal 12 and the server device 18 thereafter repeatedly perform Steps SP10 to SP16. The creation of the content by the creator is thus continued.

FIG. 5 is a diagram illustrating an example of a data structure of the content data 62 in FIG. 3. The example of FIG. 5 represents a case where the content data 62 is a digital ink. The digital ink has a data structure formed by sequentially arranging [1] document metadata (document metadata), [2] semantic data (ink semantics), [3] device data (devices), [4] stroke data (strokes), [5] classification data (groups), and [6] context data (contexts).

The stroke data 66 is data for describing individual strokes constituting the content resulting from handwriting. The stroke data 66 represents the shapes of the strokes constituting the content and the stroke order of the strokes. As is understood from FIG. 5, one stroke is described by a plurality of pieces of point data sequentially arranged within a <trace> tag. Each piece of point data is constituted by at least an indicated position (an X-coordinate and a Y-coordinate), and is delimited by a delimiter such as a comma. For clarity of illustration, only point data representing start points and end points of the strokes are illustrated, and point data representing a plurality of middle points is omitted. The point data may include not only the indicated position as described above but also the order of generation or editing of the strokes, or the pen pressure, tilt angle, and orientation of the electronic pen 14, and the like.

FIG. 6 is a diagram illustrating an example of the content created by the creator. The content in FIG. 6 is digital art 70 created by handwriting. The creator completes the desired digital art 70 using the creator terminal 12 and the electronic pen 14. The digital art 70 is created through a series of operations by the creator or a plurality of types of creation processes.

FIG. 7 is a diagram illustrating transitions of the drawing state of the digital art 70 in FIG. 6. A first in-progress work 70a represents a drawing state in a “composition process” to set a general layout. A second in-progress work 70b represents a drawing state in a “line drawing process” to create a line drawing. A third in-progress work 70c represents a drawing state in a “coloring process” to add coloring. A fourth in-progress work 70d represents a drawing state in a “finishing process” to finish the content.

FIG. 8 is a diagram illustrating an example of a content editing screen 72 that is displayed on the display 24 of the creator terminal 12. Arranged on the content editing screen 72 are the digital art 70 being created or after being completed, a tool bar 74 provided with a group of icons which are assigned various drawing functions, and two icons 76 and 78 assigned two different types of creation assistance functions.

In Step SP18 in FIG. 4, the creator terminal 12 requests reproduction of the content within the creation period. Specifically, when receiving a specific request operation by the creator, the creator terminal 12 transmits reproduction request data including a specified point of time and a content ID. The “specific operation” corresponds to a selecting operation of touching or clicking the icon 76 in FIG. 8, for example.

In Step SP20, the server device 18 identifies the accumulated data 58 and the specified point of time based on the reproduction request data transmitted in Step SP18, and generates reproduction data 60 corresponding to the specified point of time by using the corresponding accumulated data 58. FIG. 9 is a functional block diagram illustrating a relation between a first drawing application AP1 and a second drawing application AP2. The creator-side controller 21 of the creator terminal 12 executes the first drawing application AP1 having a generation function GF and a first reproduction function RF1. The generation function GF is a function of generating the content data 62 representing the drawing of the content. The first reproduction function RF1 is a function of visibly reproducing the content based on the content data 62.

The server-side controller 42 of the server device 18 executes the second drawing application AP2 having a second reproduction function RF2. The second reproduction function RF2 is a function identical or corresponding to the first reproduction function RF1, and is a function of visibly reproducing the content based on the content data 62. The “identical function” means, for example, the same version of the software in which an identical output result is obtained based on identical input data. The “corresponding function” means, for example, different versions of the software in which substantially similar output results may be obtained based on identical input data.

First, during the execution of the first drawing application AP1, the partial data 56 including the content data 62 is generated in units of content creation through the generation function GF. Then, the partial data 56 is transmitted from the creator terminal 12, and is thereafter sequentially deleted from the creator terminal 12. Timing of the deletion of the partial data 56 may be, for example, [1] a point of time at which an accumulated amount of the partial data 56 reaches an upper limit value, [2] a point of time at which a storage period of the partial data 56 has expired, [3] a point of time at which the transmission of the partial data 56 is completed, or [4] a point of time at which the execution of the first drawing application AP1 is ended.

Because the partial data 56 is sequentially deleted in chronological order from the old data, reproduction data 60c corresponding to the content being created (corresponding to the latest point of time of creation) is generated through the first reproduction function RF1. That is, the content being created (for example, the in-progress work 70c in FIG. 7) is visibly reproduced on the display 24 of the creator terminal 12.

Meanwhile, the server device 18 accumulates the partial data 56 sequentially transmitted from the creator terminal 12, and stores the accumulated data 58 corresponding to the latest creation point of time. When the second drawing application AP2 is executed, reproduction data 60a, 60b, and 60c corresponding to the specified point of time specified by the creator is generated through the second reproduction function RF2, and is transmitted from the server device 18. The content within the creation period (for example, the in-progress works 70a to 70c in FIG. 7) is thereby visibly reproduced on the display 24 of the creator terminal 12.

In Step SP22 in FIG. 4, the server device 18 provides an instruction to display the content by transmitting the reproduction data 60 generated in Step SP20 to the corresponding creator terminal 12.

In Step SP24, the creator terminal 12 reproduces and displays the content at the specified point of time specified by the creator according to the instruction of Step SP22.

FIG. 10 is a diagram illustrating an example of a content reproduction screen 80 that is displayed on the display 24 of the creator terminal 12. Arranged on the content reproduction screen 80 are a drawing display section 82 illustrating the drawing state of the digital art 70 (FIG. 6), user controls 84 and 86 related to the selection of the drawing state, and a button 88 depicted as [BACK]. The [BACK] button 88 corresponds to a user control for returning to the display of the content editing screen 72 (FIG. 8).

The user control 84 is constituted by a plurality of buttons, for example. The user control 84 is provided so as to make it possible to perform various operations related to the reproduction of creation processes of the digital art 70. The user control 86 is constituted by a slide bar, for example. The user control 86 is provided so as to make it possible to select a relative completion degree (any value between 0% and 100%) of the digital art 70. Here, a completion degree of “0%” corresponds to the starting point of time of the creation, whereas a completion degree of “100%” corresponds to the latest point of time of the creation. That is, when a specifying operation by the creator is received, a specified point of time within the creation period is identified, and the drawing display section 82 is updated in real time.

In Step SP26 in FIG. 4, the creator terminal 12 checks whether or not an ending operation to end the display of the content reproduction screen 80 (an operation of the button 88 illustrated in FIG. 10 in this case) is received. When the ending operation is not yet received (Step SP26: NO), the creator terminal 12 returns to Step SP24, and sequentially repeats Steps SP24 and SP26 until the ending operation is received. When the ending operation is received on the other hand (Step SP26: YES), the creator terminal 12 proceeds to next Step SP28.

In Step SP28, the creator terminal 12 ends the display of the content reproduction screen 80 illustrated in FIG. 10, and resumes the display of the content editing screen 72 illustrated in FIG. 8. Thus, through the data collection section M1 of the creation assistance system 10, the creator finishes the content including the digital art 70.

That is, the data collection section M1 plays a role of a guardian angel quietly assisting the creator without interfering with the creation by the creator. In addition, because various types of data generated by the creator terminal 12 through the creation of the digital art 70 are backed up by the server device 18, the creator can look back through the long creation period of the digital art 70.

### Function Effects

As described above, the creation assistance system 10 in the present embodiment includes the creator terminal 12 for creating the content (digital art 70 in this case) through an input operation by the creator, and the server device 18 capable of communicating bidirectionally with the creator terminal 12. The creator terminal 12 includes the creator-side controller 21 and the creator-side storage 22. The server device 18 includes the server-side controller 42 and the server-side storage 44.

The creator-side controller 21 executes the first drawing application AP1 including the generation function GF of generating the content data 62 representing the drawing of the digital art 70 and the first reproduction function RF1 of visibly reproducing the digital art 70 from the content data 62, and performs communication control so as to transmit, to the server device 18, the partial data 56 including the content data 62 generated in units of content creation of the digital art 70 through the generation function GF of the first drawing application AP1.

The server-side storage 44 stores the accumulated data 58 by accumulating the partial data 56 received from the creator terminal 12. The server-side controller 42 executes the second drawing application AP2 including the second reproduction function RF2 identical or corresponding to the first reproduction function RF1, generates the reproduction data 60 for visibly reproducing the digital art 70 being created or after being completed, by using the content data 62 included in the accumulated data 58 stored in the server-side storage 44 through the second reproduction function RF2 of the second drawing application AP2, and performs communication control so as to transmit the generated reproduction data 60 to the creator terminal 12.

With such configuration, the server device 18 can vicariously perform the reproduction of the digital art 70, to thereby reduce the computation load on the creator terminal 12 associated with rendering processing.

In addition, the creator-side controller 21 may perform communication control so as to transmit reproduction request data including a specified point of time specified by the creator in the creation period of the digital art 70. In this case, the server-side controller 42 generates the reproduction data 60 corresponding to the specified point of time included in the reproduction request data received from the creator terminal 12, and performs communication control to transmit the reproduction data 60 to the creator terminal 12. The creator can thereby view the digital art 70 at various points of time of the creation process through the display of the reproduction data 60 by the creator terminal 12.

The creation period may be a period from the starting point of time of the creation of the digital art 70 to the latest point of time of the creation. Thus, the creator can retrospectively view the digital art 70 even before completion.

After the creator-side controller 21 transmits the partial data 56 to the server device 18, the creator-side controller 21 may erase the partial data 56 from the creator-side storage 22. Thus, a lower storage capacity of the creator-side storage 22 suffices as compared with a case where the creator terminal 12 retains the partial data 56.

In a case where the accumulated data 58 includes vector data which describes the digital art 70 in a vector format, and the reproduction data 60 includes raster data which describes the digital art 70 in a raster format, the first reproduction function RF1 and the second reproduction function RF2 may include a rasterizing function of converting the vector data into the raster data. It is thereby possible to reduce a computation load on the creator terminal 12 associated with rasterization processing.

### Description of Data Analysis Function

A second function (a data analysis function) implemented by the creation assistance system 10 will next be described with reference to FIGS. 11 to 14.

### Functional Block Diagram

FIG. 11 is a diagram illustrating functional blocks of the data analysis section M2 in FIG. 2 and a data configuration of the second data group G2 in FIG. 2. This data analysis section M2 functions as a data obtaining section 100, a feature quantity calculating section 102, and a content evaluating section 104. The second data group G2 includes not only the accumulated data 58 described above but also graph information 106, drawing pattern information 108, derived information 110, and evaluation result information 112.

The data obtaining section 100 obtains the accumulated data 58 collected through the data collection section M1. The accumulated data 58 includes the content data 62 and the related data 64 described above.

The feature quantity calculating section 102 calculates feature quantities related to the content on a time-series basis based on at least one of the content data 62 and the related data 64 obtained by the data obtaining section 100. The feature quantities include [1] feature quantities related to drawing states of the content (hereinafter referred to as “state feature quantities”) and [2] feature quantities related to a single operation or consecutive operations performed to create the content (hereinafter referred to as “operation feature quantities”). A timeseries of the state feature quantities or a timeseries of the operation feature quantities corresponds to a drawing pattern EM which is a pattern unique to the content.

Examples of the state feature quantities include [1] the type or the number of words constituting a word group, or [2] coordinate values in a feature quantity space defined by a conceptual graph. Examples of the operation feature quantities include the magnitude or direction of a vector having, as a starting point, a first drawing state immediately before an operation is performed, and having, as an end point, a second drawing state immediately after the operation is performed.

The content evaluating section 104 performs evaluation processing to evaluate the content by using the timeseries of the state feature quantities or the operation feature quantities calculated by the feature quantity calculating section 102. The content evaluating section 104 evaluates, for example, [1] a style of the content, [2] a habit of the creator, [3] a mental state of the creator, or [4] a state of the external environment. Here, the “style” refers to the characteristic or the idea of the creator appearing in the content. Examples of the “habit” include use of colors, a stroke drawing characteristic, a tendency in apparatus usage, a degree of operation errors, and the like. Examples of the “mental state” include not only the creator's emotions including delight, anger, sorrow, and pleasure, but also various states such as sleepiness, relaxation, and nervousness. Examples of the “external environment” include the brightness of surroundings, temperature, weather, season, and the like.

In addition, the content evaluating section 104 obtains a degree of similarity between a timeseries of feature quantities corresponding to the content to be evaluated (that is, first timeseries feature quantities) and a timeseries of feature quantities corresponding to genuine (authentic) content (that is, second timeseries feature quantities), and determines the authenticity of the content to be evaluated on the basis of the degree of similarity. The degree of similarity may be indicated by various indexes including, for example, a correlation coefficient, a norm, and the like.

The graph information 106 includes various types of information which describes a conceptual graph (or an ontology graph) indicating a relation between words. The graph information 106 includes [1] “node information” such as identification information of a node (that is, a node ID), a word name, and a coordinate value (a so-called distributed representation) in the feature quantity space, and [2] “link information” such as identification information of a link (that is, a link ID), the presence or absence of a link between nodes, and a label given to each link.

Each word constituting a node is associated with a coordinate value in an N-dimensional (for example, N≥3) feature quantity space. That is, each word is quantified as a “distributed representation” of natural language processing. Words include a noun, an adjective, an adverb, a verb, or a compound word as a combination thereof. Words are not limited to a word which directly expresses a form of the content (for example, the type, color, shape, pattern, or the like of an object), but may include a word which indicates a conceptual or abstract impression including an emotion or a mental state.

The drawing pattern information 108 includes the drawing pattern EM defined in the feature quantity space described above or a processed drawing pattern EM. Here, the “drawing pattern” refers to a set or a trace of points in the feature quantity space for representing the state feature quantities. Examples of the “processed drawing pattern” include a drawing pattern EM in which the number of dimensions is reduced (that is, a sectional view), a drawing pattern EM in which the number of points is thinned out, and the like. The drawing pattern information 108 is stored in association with the identification information that can identify the content or the creator.

The derived information 110 is information derived from the drawing pattern information 108. The derived information 110 includes, for example, visible information for giving awareness to the creator of the content (hereinafter referred to as “awareness information”). Examples of the awareness information include [1] a word group as state feature quantities, and [2] other expressions obtained by abstracting or euphemizing words included in the word group (for example, symbols indicating the strength of features, other words having high similarity, and the like). As with the drawing pattern information 108, the derived information 110 is stored in association with the identification information of the content or the creator.

The evaluation result information 112 represents a result of evaluation of the content by the content evaluating section 104. Examples of the evaluation result include [1] a result of single evaluation including a classification category, a score, a creation process, and the like, and [2] a result of comparative evaluation including a degree of similarity, an authenticity determination, and the like.

FIG. 12 is a diagram illustrating an example of a data structure of the graph information 106 in FIG. 11. The graph information 106 represents data in a table format to indicate a correspondence relation between the “node information” related to nodes constituting a graph and the “link information” related to links constituting the graph. In the example of FIG. 12, the node information includes a node ID, a word name, a distributed representation, and a display flag. The link information includes the presence or absence of a link between nodes and a label attached to each link.

FIG. 13 is a diagram illustrating an example of a data structure of the drawing pattern information 108. This drawing pattern information 108 represents data in a table format to indicate a correspondence relation between a “state ID” as identification information of a drawing state of the digital art 70 and “state feature quantities” related to the drawing state. The state feature quantities include, for example, a first word group, a second word group, and a coordinate value. The “first word group” corresponds to an aggregate of words converted from the content data 62. The “second word group” is an aggregate of words converted from the related data 64. The “coordinate value” is defined in the N-dimensional feature quantity space. The number of dimensions N is an integer of three or more, and is preferably a numerical value on the order of a few hundreds.

FIG. 14 is a diagram illustrating an example of a visualized drawing pattern EM. For the convenience of illustration, the feature quantity space is represented by a plane coordinate system having a first component and a second component as two axes. The drawing pattern EM in the present figure represents a series of creation processes from the starting point of time of the creation of the digital art 70 to the ending point of time of the creation of the digital art 70. More specifically, the drawing pattern EM is an aggregate of representative points calculated for each stroke operation. In the example of FIG. 14, the drawing pattern EM is depicted as a set of points in the feature quantity space. However, instead, the drawing pattern EM may be a single line (a trace) formed by sequentially connecting points to one another.

### Function Effects

As described above, the creation assistance system 10 in the present embodiment includes the creator terminal 12 for creating the content (digital art 70 in this case) through an input operation by the creator, and the server device 18 capable of communicating bidirectionally with the creator terminal 12. The creator terminal 12 includes the creator-side controller 21 and the creator-side storage 22. The server device 18 includes the server-side controller 42 and the server-side storage 44.

The server-side controller 42 of the server device 18 calculates a state feature quantity related to a drawing state within the creation period of the digital art 70 by using at least one of the content data 62 representing the drawing of the digital art 70 or the related data 64 related to the creation of the digital art 70, and generates the drawing pattern information 108 representing the drawing pattern EM as a set or a trace of points in the feature quantity space which represents the calculated state feature quantity.

The drawing pattern EM, which is the set or the trace of the points in the feature quantity space representing the state feature quantity related to the drawing state, is thus generated. It is therefore possible to evaluate the digital art 70 more precisely as compared with a case where the digital art 70 is evaluated by simply using the drawn content of a completed article. In addition, the drawing pattern EM is generated through complex arithmetic processing, and can therefore be information unique to the digital art 70. That is, through the usage of the drawing pattern EM, more reliable authentication becomes possible, and various values related to the digital art 70 can be protected.

### Description of Data Representing Function

A third function (a data representing function) implemented by the creation assistance system 10 will next be described with reference to FIG. 15 and FIG. 16.

### Functional Block Diagram

FIG. 15 is a diagram illustrating functional blocks of the data representing section M3 in FIG. 2 and a data configuration of the third data group G3 in FIG. 2. The data representing section M3 functions as an information generating section 120 and a display instructing section 122. The third data group G3 includes representation data 124 in addition to the drawing pattern information 108, the derived information 110, and the evaluation result information 112 described above.

The information generating section 120 generates information which assists in the creation of the content (hereinafter referred to also as “creation assistance information”) by using the generated information (the drawing pattern information 108, the derived information 110, or the evaluation result information 112) obtained through analysis processing by the data analysis section M2. In addition, the information generating section 120 is configured to update the content or the display mode of the creation assistance information in real time via a user interface of the creator terminal 12 or the fan user terminal 16.

Specifically, the display mode of the drawing pattern EM may be customized according to a preference of the creator. The display mode includes at least one of a shape, a size, a viewpoint, or a vector component selection or coloration. Examples of the coloration include [1] color values such as brightness, saturation, and hue, [2] the types or the number of colors, [3] color gamut, [4] background color, and the like.

The display instructing section 122 provides an instruction to display the creation assistance information generated by the information generating section 120. The “display” includes not only a case of displaying on an output device (not illustrated) of the server device 18 but also a case of transmitting the representation data 124 including the creation assistance information to an external device such as the creator terminal 12.

The representation data 124 includes information which directly or indirectly represents the content, for example, the generated information obtained by the data analysis section M2 or the creation assistance information obtained by processing the generated information.

### Description Of Operation

A data representing operation by the creation assistance system 10 will next be described with reference to FIG. 15 and FIG. 16.

The creator terminal 12 requests a representation of a result of analysis of the content within the creation period. Specifically, when receiving a specific request operation by the creator, the creator terminal 12 transmits representation request data including a specified point of time and a content ID. The “specific operation” corresponds to, for example, a selecting operation of touching or clicking an icon 78 (Awareness Information (AI) 140 in FIG. 16) illustrated in FIG. 8.

The server device 18 identifies the accumulated data 58 and the specified point of time based on the representation request data transmitted from the creator terminal 12, and generates the representation data 124 corresponding to the specified point of time. Then, the server device 18 provides an instruction to represent a result of analysis of the content, by transmitting the representation data 124 generated by the server device 18 to the corresponding creator terminal 12. Then, the creator terminal 12 displays the result of analysis of the content at the specified point of time by using the received representation data 124.

FIG. 16 is a diagram illustrating an example of an analysis result screen 130 that is displayed on the display 24 of the creator terminal 12. Arranged on the analysis result screen 130 are an information presenting section 132 for presenting the drawing pattern information 108, a drawing display section 134 illustrating a drawing state of the digital art 70, a user control 136 for a selection of the drawing state, an information presenting section 138 for presenting the evaluation result information 112, an information presenting section 140 for presenting the derived information 110 (e.g., the awareness information), a button 142 depicted as [COLOR SETTING], and a button 144 depicted as [BACK].

The user control 136 is constituted by a slide bar, for example. The user control 136 is provided so as to make it possible to select a relative completion degree (any value between 0% and 100%) of the digital art 70. That is, when a specifying operation by the creator is received, a given point of time within the creation period (that is, a specified point of time) is identified, and the information presenting sections 132, 138, and 140 and the drawing display section 134 are updated in real time.

The [COLOR SETTING] button 142 corresponds to a user control to set a display color of the drawing pattern EM displayed in the information presenting section 132. For example, when an operation of the [COLOR SETTING] button 142 is received, a display color setting screen is displayed in a pop-up manner. The creator can thereby customize the display color (for example, a color value, a background color, or the like) of the drawing pattern EM according to a preference of the creator.

As illustrated in FIG. 16, the creator terminal 12 may display the drawing pattern information 108, the derived information 110, or the evaluation result information 112 together with the digital art 70. Specifically, by reproducing and presenting the creation process thus far to the creator in response to the creator's request, the analysis result screen 130 can assist the creator in finding a clue related to the creation. In addition, the creator can search for a clue for further development and growth by reviewing the creator's own style and the creation process.

### Function Effects

As described above, the creation assistance system 10 in the present embodiment includes the creator terminal 12 for creating the content (digital art 70 in this case) through an input operation by the creator, and the server device 18 capable of communicating bidirectionally with the creator terminal 12. The creator terminal 12 includes the creator-side controller 21 and the creator-side storage 22. The server device 18 includes the server-side controller 42 and the server-side storage 44.

The creator-side controller 21 may perform communication control so as to transmit representation request data including a specified point of time specified by the creator in the creation period of the digital art 70. In this case, the server-side controller 42 generates the drawing pattern information 108 corresponding to the specified point of time included in the representation request data received from the creator terminal 12, and performs communication control so as to transmit the representation data 124 including the drawing pattern information 108 to the creator terminal 12. With such a configuration, the server device 18 can vicariously perform the analysis of the digital art 70, to thereby reduce the computation load on the creator terminal 12 associated with rendering processing. In addition, the creator can view the drawing pattern EM at various points of time of the creation process through the display of the drawing pattern EM by the creator terminal 12.

In addition, in a case where the creator terminal 12 further includes a display (display 24 in this case) that displays an image or video, the creator-side controller 21 may control the display 24 such that the display mode of the drawing pattern EM is changed via a user interface. The creator can thereby easily customize the display mode of the drawing pattern EM through an operation via the user interface.

The display mode may be the coloration of the drawing pattern EM. Thus, through a customization of the coloration by the creator, the artistic quality of the drawing pattern EM itself generated from the digital art 70 can be enhanced, to add further value to the digital art 70. The drawing pattern EM having high artistic quality may be used, for example, as a piece of art, texture, background material, or the like.

### Description of Data Learning Function

A fourth function (a data learning function) implemented by the creation assistance system 10 will next be described with reference to FIG. 17 and FIG. 18.

### Functional Block Diagram

FIG. 17 is a diagram illustrating functional blocks of the data learning section M4 in FIG. 2 and a data configuration of the fourth data group G4 in FIG. 2. The data learning section M4 functions as a data processing section 160, a learning processing section 162, an event detecting section 164, and an assistance processing section 166. The fourth data group G4 includes a learning data group 170, one or more types of learning parameter groups 172, and assistance information 174 in addition to the accumulated data 58 described above.

The data processing section 160 generates learning data used for machine learning by performing data processing on the accumulated data 58. The learning data group 170 is updated through the accumulation of the learning data.

The learning processing section 162 performs learning processing on a discriminator 180 (FIG. 18) constituted by a neural network or the like by using the learning data group 170, to be described later. The respective values of learning parameters constituting the learning parameter group 172 are determined through the learning processing.

The event detecting section 164 detects the presence or absence and the type of an event, which can be a target of assistance, from the current drawing state of the creator terminal 12. In this case, the detection of an event is performed by the discriminator 180 (FIG. 18) in which the learning parameter group 172 is set. The type of an event is classified into [1] an event originating from an operation error, and [2] an event originating from a habit, illusion, or false recognition of the creator. Examples of the former include a mistake in drawing a straight line, a curve, a figure, a symbol, or the like, or unstable (fluctuating) stroke positioning or pen pressure, and the like. Examples of the latter include a timing shift in depressing a switch, an error in selecting a color in the color palette, a habitually performed unnecessary operation, and the like.

When the event detecting section 164 detects a predetermined event, the assistance processing section 166 performs assistance processing to assist the creator in the creation. Examples of the assistance processing include [1] a presentation of the occurrence of an event, [2] a presentation of the attribute and type of the event, [3] a presentation of an alternative operation, [4] cancellation of the operation, [5] correction of a stroke shape, [6] a collection of log data, and the like.

The learning data group 170 is an aggregate of learning data used for machine learning performed by the learning processing section 162. The learning data is a data set constituted by, for example, [1] a set of feature quantities in units of stroke operation, [2] a state vector indicating a state space at a time of performing a stroke operation, [3] a type (label value) of an event, and the like. The type of the learning data may be training data, verification data, or test data.

The learning parameter group 172 is an aggregate of learning parameters for identifying a computation rule of the discriminator 180. The learning parameter group 172 includes “variable parameters” which are updated at a time of learning and “fixed parameters” (hyperparameters) which are not updated the time of learning. Examples of the variable parameters include a coefficient describing an activation function of a computing unit, a coupling strength between computing units, and the like. Examples of the fixed parameters include the number of computing units, the number of intermediate layers 184 (FIG. 18), the kernel size of a convolution operation, and the like.

The learning parameter group 172 may be uniform irrespective of the creator, or may be customized for each creator. In the latter case, it is preferable that the learning parameter group 172 be stored in advance in association with identification information capable of identifying the creator and be read at an appropriate time by using the identification information included in the content data 62. The identification information may be a usage account of the creation assistance service, or various IDs related to the electronic pen 14 or the creator terminal 12, for example.

The assistance information 174 includes various types of information for assisting in the creation by the creator. Examples of the assistance information 174 include [1] the attribute and type of an event that has occurred, [2] the content of an alternative operation or a canceling operation; [3] content indicating a stroke shape after a correction, and the like.

### Description of Operation

The fourth function (the data learning function) implemented by the creation assistance system 10 will next be described with reference to FIG. 17 and FIG. 18.

First, the data processing section 160 processes the accumulated data 58 transmitted from the creator terminal 12, and generates learning data for each creator. The learning data group 170 integrated for each creator is thereby updated. Then, for example, when the number of pieces of accumulated data or an amount of accumulated data exceeds a threshold value, the learning processing section 162 starts learning processing on the discriminator 180.

FIG. 18 is a diagram illustrating an example of a network structure of the discriminator 180. The discriminator 180 is constituted by a hierarchical neural network, for example. The discriminator 180 includes an input layer 182, an intermediate layer 184, and an output layer 186. The computation rule of the discriminator 180 is set by the respective values of the learning parameters constituting the learning parameter group 172 (FIG. 17).

The input layer 182 is a layer for inputting a state vector and operation feature quantities at a time of an operation. The input layer 182 is constituted by a plurality of {for example, (M+m)} computing units. Here, “M” corresponds to the number of components of the state vector, and “m” corresponds to the number of operation feature quantities.

The intermediate layer 184 is constituted by one layer or two layers or more. The intermediate layer 184 has a dimension reducing function of reducing the number of dimensions of the input vector. That is, the number of computing units constituting the intermediate layer 184 is preferably smaller than (M+m).

The output layer 186 is a layer that outputs a label group of events. In the example of FIG. 18, the output layer 186 is constituted by (N+1) computing units. An “event n” (n=1, . . . , N) label indicates a state in which an nth event has occurred, and a “normal” label indicates a state in which none of the events has occurred. In a case where the activation functions of the computing units are a softmax function, the label group is an output vector including (N+1) components indicating the probabilities of occurrence of the events. That is, in a case where there is a label having a maximum label value (hereinafter, a specific label), a detection result is obtained which indicates that an event corresponding to the specific label has occurred in a first operation. As a correct answer of teacher data, a one-hot vector, for example, is used in which the vector component of the event is “1,” and the other vector components are “0.”

With reference back to FIG. 17, the learning processing section 162 ends the learning processing on the discriminator 180 when a convergence condition is satisfied while [1] the calculation of a learning error, [2] a convergence determination, and [3] the updating of the learning parameters, are sequentially repeated. The respective values of the learning parameters determined through the learning processing are stored as the learning parameter group 172 in the server-side storage 44. Thereafter, with the learning parameter group 172 set in the discriminator 180, the event detecting section 164 exerts a detecting function of detecting an event as an assistance target.

### Function Effects

As described above, the creation assistance system 10 in the present embodiment includes the creator terminal 12 for creating the content (digital art 70 in this case) through an input operation by the creator, and the server device 18 capable of communicating bidirectionally with the creator terminal 12. The creator terminal 12 includes the creator-side controller 21 and the creator-side storage 22. The server device 18 includes the server-side controller 42 and the server-side storage 44.

The server-side controller 42 performs detection processing of detecting the presence or absence and the type of an event, which can be a target of assistance, from the present drawing state of the digital art 70, and performs assistance processing for assisting in the creation by the creator according to the type of the detected event.

With such a configuration, creation assistance according to the present drawing state of the digital art 70 can be provided timely and automatically, so as to further assist and benefit the creator.

The detection processing may be performed by the machine-learned discriminator 180 that has at least one feature quantity generated from the content data 62 or the related data 64 as an input and has a label value for each event as an output.

The server-side storage 44 may further store a plurality of types of learning parameter groups 172 for identifying a computation rule of the discriminator 180. In this case, the server-side controller 42 selects one type from among the plurality of types of learning parameter groups 172 according to the creator, and performs the detection processing using the discriminator 180 corresponding to the selected learning parameter group 172. Consequently, a creation tendency of the creator can be reflected, and event detection accuracy can be correspondingly improved.

### Description of Data Sharing Function

A fifth function (a data sharing function) implemented by the creation assistance system 10 will next be described with reference to FIGS. 19 to 23.

### Functional Block Diagram

FIG. 19 is a diagram illustrating functional blocks of the data sharing section M5 in FIG. 2 and a data configuration of the fifth data group G5 in FIG. 2. This data sharing section M5 functions as a management processing section 200, an information obtaining section 202, a display instructing section 204, and an accounting processing section 206. The fifth data group G5 includes user information 210, copyrighted work information 212, and shared data 214.

The management processing section 200 uses the user information 210 and the copyrighted work information 212 to manage users who share the content and manage copyrights of the content. For example, when an event has occurred which involves the addition, change, or removal of a creator or a fan user, or accounting processing, the management processing section 200 updates the user information 210 according to the event. When an event has occurred which includes the addition, modification, or deletion of the content, the management processing section 200 updates the copyrighted work information 212 according to the event.

The information obtaining section 202 obtains information regarding the content to be shared (hereinafter referred to also as “content information”). The content information includes, for example, the reproduction data 60, the drawing pattern information 108, the derived information 110, or the evaluation result information 112.

The display instructing section 204 instructs the fan user terminal 16 to display a usability list 216 in response to first viewing request data received from the fan user terminal 16 (a first request from the fan user). Specifically, the display instructing section 204 performs communication control so as to transmit the usability list 216 generated by the management processing section 200 to the corresponding fan user terminal 16.

The display instructing section 204 instructs the fan user terminal 16 to display the content information in response to second viewing request data received from the fan user terminal 16 (a second request of the fan user) provided that the fan user belongs to a defined community. Specifically, the display instructing section 204 performs communication control so as to transmit the content information obtained by the information obtaining section 202 to the corresponding fan user terminal 16.

The accounting processing section 206 periodically or non-periodically performs accounting processing related to the usage of a primary copyrighted work and a secondary copyrighted work in the content. For example, each time the content is used, the accounting processing section 206 calculates an amount to be received by the creator and an amount to be paid by the fan user according to a predetermined calculation rule. The calculation rule may be made to differ between the primary copyrighted work and the secondary copyrighted work. Here, the “calculation rule differing” means that at least one of a calculation formula to determine an overall usage fee, a coefficient of the calculating formula, and a split ratio of the usage fee may differ.

The user information 210 includes various types of information related to service users. The user information 210 includes [1] “personal information” including the identification information, name, and attribute of a service user, [2] “affiliation information” indicating a community (or a group) to which the service user belongs, [3] “usage information” indicating usage conditions or charging conditions of the service, [4] “terminal information” including the identification information and network information of a terminal device possessed by the service user, or the like.

The copyrighted work information 212 includes various types of information related to the creation of a copyrighted work or a right arising from the creation. The copyrighted work information 212 includes [1] “creation information” including the name of the creator, creation date and time, and creation location, [2] “first classification information” indicating whether the copyrighted work is a primary copyrighted work, a secondary copyrighted work, or a free copyrighted work, [3] “second classification information” indicating whether or not the copyrighted work is a work made for hire, [4] a “calculating method” for determining a usage fee for the copyrighted work, or the like.

The shared data 214 includes content information shared between a plurality of users. The shared data 214 includes, for example, the reproduction data 60, the drawing pattern information 108, the derived information 110, or the evaluation result information 112.

### Description of Operation

A data sharing operation by the creation assistance system 10 will next be described with reference to FIGS. 19 to 23.

First, the fan user uses the fan user terminal 16 to perform a specific operation to request viewing of a list of content currently usable (accessible) by the fan user (that is, the usability list 216). When the fan user terminal 16 receives the specific operation by the fan user, the fan user terminal 16 transmits first viewing request data including the user ID. Then, the server-side controller 42 (more specifically, the management processing section 200) of the server device 18 generates the corresponding usability list 216 by using the user ID included in the received first viewing request data.

FIG. 20 is a diagram illustrating an example of a data structure of the user information 210 in FIG. 19. The user information 210 indicates a correspondence relation between the user ID, a “membership type” indicating a right to use the service, a “group” to which the user belongs, a “payment history” indicating conditions of payment of a usage fee of a copyrighted work, and a “reception history” indicating conditions of reception of the usage fee of the copyrighted work. Examples of the “membership type” include a “creator” having a right to produce the primary copyrighted work, a “general member” having a right to view the primary copyrighted work, and a “special member” having a right to view the primary copyrighted work and the secondary copyrighted work.

FIG. 21 is a diagram illustrating an example of a data structure of the copyrighted work information 212 in FIG. 19. The copyrighted work information 212 indicates a correspondence relation between a “content ID” indicating the identification information of content, a type of copyrighted work indicating the type of the copyrighted work, an “author” of the content, and a “calculating method” related to the usage fee of the copyrighted work. Examples of the “type of copyrighted work” include a primary copyrighted work, a secondary copyrighted work, or a free copyrighted work (copyrighted work whose copyright has lapsed or has been relinquished).

The server-side controller 42 refers to the user information 210 in FIG. 20 and the copyrighted work information 212 in FIG. 21, identifies one or more content allowed to be used by the fan user, and generates the usability list 216 including the content. Then, the server device 18 provides an instruction to display the usability list 216 by transmitting the usability list 216 to the corresponding fan user terminal 16.

FIG. 22 is a diagram illustrating an example of a list viewing screen 220 that is displayed on the display 34 of the fan user terminal 16. Arranged on the list viewing screen 220 are an information presenting section 222 for presenting the user information 210 and a list presenting section 224 for presenting the usability list 216. Provided within the list presenting section 224 is the copyrighted work information 212 (art name, type, author, and creation date and time in this case) for each content as well as a button 226 depicted as [VIEW] and a button 228 depicted as [EDIT].

Here, the fan user views the usability list 216 presently displayed, and performs a specific operation to request use of content (operation of the [VIEW] button 226 in this case). When the fan user terminal 16 receives the specific operation, the fan user terminal 16 transmits second viewing request data including the user ID and the content ID.

Then, the server-side controller 42 (more specifically, the information obtaining section 202) of the server device 18 obtains corresponding content information (specifically, the reproduction data 60, the drawing pattern information 108, the derived information 110, or the evaluation result information 112) by using the content ID included in the received second viewing request data. Then, the server device 18 provides an instruction to display the corresponding content information by transmitting the content information to the corresponding fan user terminal 16.

FIG. 23 is a diagram illustrating an example of an analysis result screen 230 that is displayed on the display 34 of the fan user terminal 16. In the example of FIG. 23, the analysis result screen 230 is the same as the analysis result screen 130 in FIG. 16, but may be a screen at least partially different from the analysis result screen 130. Here, when an operation of the user control 136 by the fan user is received, a given point of time within the creation period (that is, a specified point of time) is identified, and the information presenting sections 132, 138, and 140 and the drawing display section 134 are updated in real time.

With reference back to FIG. 22, the fan user views the usability list 216 currently displayed, and performs a specific operation to request editing of content (an operation of the [EDIT] button 228 in this case). When the fan user terminal 16 receives the specific operation, the fan user terminal 16 transmits second viewing request data including the user ID and the content ID.

Then, the server-side controller 42 (more specifically, the information obtaining section 202) of the server device 18 obtains the corresponding reproduction data 60 by using the content ID included in the received second viewing request data. Then, the server device 18 provides an instruction to display the digital art 70 by transmitting the corresponding reproduction data 60 to the corresponding fan user terminal 16. Then, the content editing screen 72 (FIG. 8) is displayed on the display 34 of the fan user terminal 16. The fan user can thereby perform various edits such as [1] leaving a comment for the digital art 70, or [2] processing the digital art 70 within a scope permitted by the creator.

That is, the data sharing section M5 plays a role of allowing the digital art 70 itself or the creation process of the digital art 70 to be shared between the creator and the fan user (including another creator). It thus provides a “new way of enjoying” the digital art 70 and provides a creation environment in which multiple creators can stimulate each other.

### Function Effects

As described above, the creation assistance system 10 in the present embodiment includes the fan user terminal 16 that can display the content created by the creator (digital art 70 in this case), and the server device 18 that capable of communicating bidirectionally with the fan user terminal 16. The server device 18 includes the server-side controller 42 and the server-side storage 44.

The server-side storage 44 stores community information (the user information 210 and the copyrighted work information 212) indicating a correspondence relation between the digital art 70, a community related to the digital art 70, and a constituent member of the community. The server-side controller 42 transmits the shared data 214 including the content information related to the primary copyrighted work or the secondary copyrighted work in the content to the fan user terminal 16 in response to a request from the fan user terminal 16 provided that the fan user belongs to the community.

With such a configuration, the fan user belonging to the community can view the primary copyrighted work or the secondary copyrighted work in the digital art 70, such that the fan user can share the world view of the digital art 70.

The server-side controller 42 may transmit the usability list 216 representing a list of content usable by a constituent member associated with the fan user terminal 16 to the fan user terminal 16 in response to a request from the fan user terminal 16. Thus, by visually checking the usability list 216, the fan user can understand at a glance which digital art 70 is usable by the fan user.

### OTHER EXAMPLES

It is to be noted that the creation assistance system 10 may be not only applied at a time of creation of content in the art industry but also applied to assist “learning” in the education industry. In this case, the digital art 70 (content) described above is replaced with a “product of learning” including a notebook, homework, and an answer sheet. The creator terminal 12 and the fan user terminal 16 (user terminals) described above may be replaced with “a plurality of student terminals” sharing the content information. In addition, the drawing pattern EM described above is replaced with a “learning pattern” indicating a learning process of a student.

In this case, the data collection section M1 collects the partial data 56 including a product of learning which is input by handwriting using a student terminal, and transmits the reproduction data 60 indicating the product of learning, which is in the making or is completed, to the student terminal in response to a request from the student. The data analysis section M2 calculates a state feature quantity related to a drawing (input) state of the product of learning, and generates learning pattern information indicating the “learning pattern” as a set or a trace of points in the feature quantity space which represents the calculated state feature quantity. The data representing section M3 transmits the representation data 124 including the learning pattern information related to the product of learning in the making or as completed to the student terminal in response to a request from the student terminal.

The data learning section M4 performs detection processing of detecting the presence or absence and the type of an event, which can be a target of assistance, from the current drawing state of the product of learning, and performs assistance processing to assist in the learning by the student according to the type of the detected event. In response to a request from a student terminal possessed by a constituent member (student B) of a school class, the data sharing section M5 transmits the content information related to a product of learning created by another constituent member (student A) to the student terminal.

### Modifications

It is to be noted that the present disclosure is not limited to the foregoing embodiments, and can obviously be modified freely without departing from the scope of the present disclosure. Alternatively, configurations may be optionally combined with each other within the scope where no technical inconsistency arises. Alternatively, the order of execution of steps constituting a flowchart may be changed within the scope where no technical inconsistency arises.

1. A creation assistance system, comprising:
a creator terminal configured to create content through an input operation by a creator; and
a server device capable of communicating bidirectionally with the creator terminal,
wherein,
the creator terminal includes a creator-side controller and a creator-side storage,
the creator-side controller is configured to:
execute a first drawing application having a generation function to generate content data representing drawing of the content and a first reproduction function to visibly reproduce the content based on the content data, and
perform communication control to transmit, to the server device, partial data including the content data which is generated in units of content creation,
the server device includes a server-side controller and a server-side storage,
the server-side storage is configured to store accumulated data by accumulating the partial data received from the creator terminal, and
the server-side controller is configured to:
execute a second drawing application having a second reproduction function identical or corresponding to the first reproduction function,
generate reproduction data to visibly reproduce the content which is being created or has been completed, by using the content data included in the accumulated data stored in the server-side storage through the second reproduction function of the second drawing application, and
perform communication control to transmit the generated reproduction data to the creator terminal.

2. The creation assistance system according to claim 1, wherein
the creator-side controller performs communication control to transmit reproduction request data including a specified point of time specified by the creator in a creation period of the content, and
the server-side controller generates the reproduction data corresponding to the specified point of time included in the reproduction request data received from the creator terminal, and performs communication control to transmit the reproduction data to the creator terminal.

3. The creation assistance system according to claim 2, wherein
the creation period is a period from a starting point of time of creation of the content to a latest point of time of the creation.

4. The creation assistance system according to claim 3, wherein
the creator-side controller erases the partial data from the creator-side storage after transmitting the partial data to the server device.

5. The creation assistance system according to claim 1, wherein
the accumulated data includes vector data describing the content in a vector format,
the reproduction data includes raster data describing the content in a raster format, and
the first reproduction function and the second reproduction function include a rasterizing function of converting the vector data into the raster data.

6. The creation assistance system according to claim 1, wherein
the server-side controller:
calculates a state feature quantity related to a drawing state in a creation period of the content by using at least one of the content data or related data related to creation of the content, and
generates drawing pattern information representing a drawing pattern as a set or a trace of points in a feature quantity space which represents the calculated state feature quantity.

7. The creation assistance system according to claim 6, wherein
the creator-side controller performs communication control to transmit representation request data including a specified point of time specified by the creator in the creation period, and
the server-side controller generates the drawing pattern information corresponding to the specified point of time included in the representation request data received from the creator terminal, and performs communication control to transmit representation data including the drawing pattern information to the creator terminal.

8. The creation assistance system according to claim 7, wherein
the creator terminal includes a display configured to display an image or video, and
the creator-side controller controls the display such that a display mode of the drawing pattern is changed via a user interface.

9. The creation assistance system according to claim 8, wherein
the display mode is coloration of the drawing pattern.

10. The creation assistance system according to claim 8, wherein
the server-side controller:
performs detection processing to detect presence or absence and a type of an event, which is a target of assistance, from a current drawing state of the content, and
performs assistance processing to assist in the creation by the creator according to the type of the detected event.

11. The creation assistance system according to claim 10, wherein
the detection processing is performed by a machine-learned discriminator that has at least one feature quantity generated from the content data or the related data as an input and has a label value for each event as an output.

12. The creation assistance system according to claim 11, wherein
the server-side storage stores a plurality of types of learning parameter groups for identifying a computation rule of the discriminator, and
the server-side controller selects one type from among the plurality of types of learning parameter groups according to the creator, and performs the detection processing using the discriminator corresponding to the selected learning parameter group.

13. The creation assistance system according to claim 1, wherein
the server-side storage stores community information indicating a correspondence relation between the content, a community related to the content, and constituent members of the community, and
in response to a request from a fan user terminal corresponding to a fan user, the server-side controller transmits shared data including content information related to a primary copyrighted work or a secondary copyrighted work in the content to the fan user terminal on condition that the fan user belongs to the community.

14. The creation assistance system according to claim 13, wherein
the server-side controller transmits a usability list representing content usable by a constituent member associated with the fan user terminal to the fan user terminal in response to a request from the fan user terminal.

15. A creation assistance method using a system including a creator terminal for creating content through an input operation by a creator and a server device capable of communicating bidirectionally with the creator terminal, the method comprising:
by the creator terminal:
executing a first drawing application having a generation function of generating content data representing drawing of the content and a first reproduction function of visibly reproducing the content from the content data, and
transmitting, to the server device, partial data including the content data which is generated in units of content creation; and
by the server device:
storing accumulated data by accumulating the partial data received from the creator terminal,
executing a second drawing application having a second reproduction function identical or corresponding to the first reproduction function,
generating reproduction data for visibly reproducing the content, which is being created or has been completed, by using the content data included in the accumulated data stored in the server device through the second reproduction function of the second drawing application, and
transmitting the generated reproduction data to the creator terminal.
